(19) United States
(12) Patent Application Publication
(10) Pub. No.: US 2024/0279400 A1
(43) Pub. Date: Aug. 22, 2024

(54) DUAL CURABLE SILICONE COMPOSITION

(71) Applicant: DOW SILICONES CORPORATION, Midland, MI (US)

(72) Inventor: Jina CHON, Chungcheongbuk-Do (KR)

(21) Appl. No.: 18/569,952

(22) PCT Filed: Jun. 20, 2022
(86) PCT No.: PCT/US2022/034166

§ 371 Date: Dec. 13, 2023

Related U.S. Application Data
(60) Provisional application No. 63/213,281, filed on Jun. 22, 2021.

(51) Int. Cl. C08G 77/14; C08F 2/44; C08F 2/50; C08F 283/12; C08G 77/00; C08L 83/06

(52) U.S. Cl. CPC C08G 77/14; C08F 2/44; C08F 2/50; C08F 283/12; C08G 77/70; C08L 83/06

(57) ABSTRACT

A dual curable silicone composition is provided. The composition comprises: (A) an epoxy-functional silicone; (B) at least one radically polymerizable compound having at least one acrylic or methacrylic group per molecule; (C) a photo acid generator and/or a thermal acid generator; and (D) a photo radical polymerization initiator and/or a thermal radical polymerization initiator. The composition generally has excellent curability without being inhibited by air and amine compounds.

### CROSS-REFERENCE TO RELATED APPLICATIONS

This application claims priority to and all advantages of U.S. Provisional Patent Application No. 63/213,281 filed on 22 Jun. 2021, the content of which is incorporated herein by reference.

### TECHNICAL FIELD

The present invention relates to a dual curable silicone composition.

### BACKGROUND ART

Epoxy-functional silicones are used for curable silicone compositions which can be cured by irradiation with ultraviolet (“UV”) ray. For example, Patent Document 1 discloses a curable silicone composition comprising: an epoxy-functional organopolysiloxane resin, an epoxy-functional organosiloxane oligomer, and a cationic photoinitiator, and Patent Document 2 discloses a curable silicone composition comprising: a cationically polymerizable organopolysiloxane containing an epoxy group, a photoacid generator, and an acrylic-silicone graft copolymer.

However, such a curable silicone composition has a problem that the composition is not sufficiently cured by amine compounds or other type of strong bases which are typically used to neutralize commonly applied photoresist materials in various electric/electronic applications. That is, the residual amine compounds or strong bases on substrates cause serious curing inhibition to the curable silicone composition.

While, acrylic-based UV curable compositions are well-known. For example, Patent Document 3 discloses a photocurable resin composition comprising: a polyol acrylate compound, a compound containing acrylic or methacrylic groups and a carboxyl group, a siloxane compound containing a glycidyl group, and a photoradical generator.

However, such a photocurable resin composition has a problem that the composition is not sufficiently cured by oxygen in the atmosphere. As a result, the cured product exhibits a tacky surface with worse mechanical properties.

Therefore, an opportunity remains to develop a curable silicone composition with excellent curability without being inhibited by air and amine compounds.

### CITATION LIST

### Patent Literature

Patent Document 1: United States Patent Application Publication No. 2014/154626 A1.
Patent Document 2: Japanese Patent Application Publication No. 2013-095874 A.
Patent Document 3: European Patent Application Publication No. 2 772 505 A1.

### SUMMARY OF INVENTION

### Technical Problem

An objective of the present invention is to provide a dual curable silicone composition with excellent curability without being inhibited by air and amine compounds.

### Solution to Problem

The dual curable silicone composition of the present invention comprises:
(A) an epoxy-functional silicone selected from (A1) an epoxy-functional silicone resin represented by the following average unit formula (1):

(R¹₃SiO_{1/2})ₐ(R¹₂SiO_{2/2})_{b}(R¹SiO_{3/2})_{c}(SiO_{4/2})_{d}
wherein each R¹ is the same or different organic group selected from a C₁₋₆ monovalent aliphatic hydrocarbon group, a C₆₋₁₀ monovalent aromatic hydrocarbon group, and a monovalent epoxy-substituted organic group, provided that at least about 15 mol % of the total R¹ are the C₆₋₁₀ monovalent aromatic hydrocarbon groups; and “a”, “b”, “c” and “d” are numbers that satisfy the following conditions: 0≤a<0.4, 0<b<0.5, 0<c<1, 0≤d<0.4, 0.1≤b/c≤0.6, and a+b+c+d=1; and about 2 to about 30 mol % of the total siloxane units have the monovalent epoxy-substituted organic groups, or a mixture of component (A1) mentioned above and (A2) an epoxy-functional silicone represented by the following general formula (2):

X¹—R²₂SiO(SiR²₂O)ₘSiR²₂—X¹
wherein each R² is the same or different organic group selected from a C₁₋₆ monovalent aliphatic hydrocarbon group and a C₆₋₁₀ monovalent aromatic hydrocarbon group; each X¹ is the same or different group selected from a monovalent epoxy-substituted organic group and an epoxy-functional siloxy group represented by the following general formula (3):

X²—R³₂SiO(SiR³₂O)ₓSiR³₂—R⁴—
wherein each R³ is the same or different C₁₋₆ monovalent aliphatic hydrocarbon group; R⁴ is a C₂₋₆ alkylene group; X² is a monovalent epoxy-substituted organic group; “x” is a number of from about 0 to about 5; and “m” is a number of from about 0 to about 100;
(B) at least one radically polymerizable compound having at least one acrylic or methacrylic group per molecule, in an amount of from about 15 mass % to about 75 mass % of the total mass of components (A) to (D);
(C) a photo acid generator and/or a thermal acid generator, in an amount of from about 0.1 mass % to about 5 mass % of the total mass of components (A) to (D); and
(D) a photo radical polymerization initiator and/or a thermal radical polymerization initiator, in an amount of from about 0.1 mass % to about 5 mass % of the total mass of components (A) to (D).

In various embodiments, a content of component (A2) is at most 80 mass % of the mixture of components (A1) and (A2).

In various embodiments, the monovalent epoxy-substituted organic groups in component (A) are glycidoxyalkyl groups, 3,4-epoxycyclohexylalkyl groups, and epoxyalkyl groups.

In various embodiments, component (B) comprises at least one of or is isobornyl acrylate, 2-hydroxyethyl methacrylate, 3-hydroxy-2,2-dimethylpropyl 3-hydroxy-2,2-dimethylpropyionate diacrylate, or 2-phenoxyethyl acrylate.

In various embodiments, component (C) comprises at least one of or is a sulfonium salt or an iodonium salt.

In various embodiments, the photo radical polymerization initiator for component (D) comprises at least one of or is an acetophenone-based initiator, benzil-based initiator, benzophenone-based initiator, thioxanthone-based initiator, acylphosphine oxide-based initiator, or an oxime-based initiator.

In various embodiments, the thermal radical polymerization initiator for component (D) is an organic peroxide with a half-life of 10 hours at a temperature of 80° C. or higher.

### Effects of Invention

The dual curable silicone composition of the present invention has excellent curability without being inhibited by air and amine compounds.

### DETAILED DESCRIPTION OF THE INVENTION

The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of 0-25, 0-10, 0-5, or ±0-2.5, % of the numerical values. Further, the term “about” applies to both numerical values when associated with a range of values. Moreover, the term “about” may apply to numerical values even when not explicitly stated. Generally, as used herein a “>” is “above” or “greater-than”; a “z” is “at least” or “greater-than or equal to”; a “<” is “below” or “less-than”; and a “s” is “at most” or “less-than or equal to.”

The terms “epoxy-functional” or “epoxy-substituted” as used herein refers to a functional group in which an oxygen atom, the epoxy substituent, is directly attached to two adjacent carbon atoms of a carbon chain or ring system. Examples of epoxy-substituted functional groups include, but are not limited to, glycidoxyalkyl groups such as 2-glycidoxyethyl groups, 3-glycidoxypropyl groups, 4-glycidoxybutyl groups, and the like; (3,4-epoxycycloalkyl)alkyl groups such as 2-(3,4-epoxycylohexyl)ethyl groups, 3-(3,4-epoxycylohexyl)propyl groups, 2-(3,4-epoxy-3-methylcylohexyl)-2-methylethyl groups, 2-(2,3-epoxycylopentyl)ethyl groups, 3-(2,3-epoxycylopentyl)propyl groups, and the like; and epoxyalkyl groups such as 2,3-epoxypropyl groups, 3,4-epoxybutyl groups, 4,5-epoxypentyl groups, and the like.

The term “(meth)acrylate” as used herein refers to either or both of acrylate and methacrylate.

### <Dual Curable Silicone Composition>

Component (A) is an epoxy-functional silicone selected from (A1) an epoxy-functional silicone resin represented by the following average unit formula (1):

(R¹₃SiO_{1/2})ₐ(R¹₂SiO_{2/2})_{b}(R¹SiO_{3/2})_{c}(SiO_{4/2})_{d}

or a mixture of component (A1) mentioned above and (A2) an epoxy-functional silicone represented by the following general formula (2):

X¹—R²₂SiO(SiR²₂O)ₘSiR²₂—X¹.

In the formula (1), each R¹ is the same or different organic group selected from a C₁₋₆ monovalent aliphatic hydrocarbon group, C₆₋₁₀ monovalent aromatic hydrocarbon group, and a monovalent epoxy-substituted organic group.

Examples of the C₁₋₆ monovalent aliphatic hydrocarbon groups in component (A1) include C₁₋₆ alkyl groups such as methyl groups, ethyl groups, propyl groups, butyl groups, and hexyl groups; C₂₋₆ alkenyl groups such as vinyl groups, allyl groups, and hexenyl groups; and C₁₋₆ halogenated alkyl groups such as 3-chloropropyl groups and 3,3,3-trifluoropropyl groups. Among these, methyl groups are generally preferred.

Examples of the C₆₋₁₀ monovalent aromatic hydrocarbon groups in component (A1) include phenyl groups, tolyl groups, xylyl groups, and naphthyl groups. Among these, phenyl groups are generally preferred.

Examples of the monovalent epoxy-substituted organic groups in component (A1) include glycidoxyalkyl groups such as 3-glycidoxypropyl groups, 4-glycidoxybutyl groups and 5-glycidoxypentyl groups; 3,4-epoxycycloalkyl alkyl groups such as 2-(3,4-epoxycylohexyl)ethyl, 3-(3,4-epoxycylohexyl)propyl, 2-(3,4-epoxy-3-methylcylohexyl)-2-methylethyl, 2-(2,3-epoxycylopentyl)ethyl, and 3-(2,3-epoxycylopentyl)propyl; and epoxyalkyl groups such as 2,3-epoxypropyl groups, 3,4-epoxybutyl groups, and 4,5-epoxypentyl groups. Among these, 3,4-epoxycycloalkyl alkyl groups are generally preferred.

In component (A1), at least about 15 mol %, optionally at least about 20 mol %, or optionally at least about 25 mol %, of the total R¹ are the C₆₋₁₀ monovalent aromatic hydrocarbon groups. If the content of the monovalent aromatic hydrocarbon groups is greater than or equal to the lower limit described above, the mechanical properties of the cured product can increase.

In the formula (1), “a”, “b”, “c”, and “d” are mole fractions and numbers that satisfy the following conditions: 0≤a<0.4, 0<b<0.5, 0<c<1, 0≤d<0.4, 0.1≤b/c≤0.6, and a+b+c+d=1, optionally a=0, 0<b<0.5, 0<c<1, 0≤d<0.2, 0.1<b/c≤0.6, and b+c+d=1, or optionally a=0, 0<b<0.5, 0<c<1, d=0, 0.1<b/c≤0.6, and b+c=1. “a” is 0≤a<0.4, optionally 0≤a<0.2, or optionally a=0, because the molecular weight of the epoxy-containing organopolysiloxane resin (A1) drops when there are too many (R¹₃SiO_{1/2}) siloxane units, and, when (SiO_{4/2}) siloxane units are introduced, the hardness of the cured product of the epoxy-functional silicone resin (A1) is markedly increased and the product can be easily rendered brittle. For this reason, “d” is 0≤d<0.4, optionally 0≤d<0.2, or optionally d=0. In addition, the molar ratio “b/c” of the (R¹₂SiO_{2/2}) units and (R¹SiO_{3/2}) units can be not less than about 0.1 and not more than about 0.6. In some examples, deviation from this range in the manufacture of the epoxy-functional silicone resin (A1) can result in generation of insoluble side products, in making the product more prone to cracking due to decreased toughness, or in a decrease in the strength and elasticity of the product and making it more prone to scratching. In some examples, the range molar ratio “b/c” is more than about 0.1 and not more than about 0.6. The epoxy-functional silicone resin (A1) contains the (R¹₂SiO_{2/2}) siloxane units and the (R¹ SiO_{3/2}) siloxane units, and its molecular structure is in most cases a network structure or a three-dimensional structure because the molar ratio of “b/c” is more than about 0.1 and not more than about 0.6. Thus, in the epoxy-functional silicone resin (A1), the (R¹₂SiO_{2/2}) siloxane units and the (RlSiO_{3/2}) siloxane units are present, whereas the (R¹₃SiO_{1/2}) siloxane units and the (SiO_{4/2}) siloxane units are optional constituent units. That is, there can be epoxy-functional silicone resins including the following average unit formulas:

(R¹₂SiO_{2/2})_{b}(R¹SiO_{3/2})_{c}

(R¹₃SiO_{1/2})ₐ(R¹₂SiO_{2/2})_{b}(R¹SiO_{3/2})_{c}

(R¹₂SiO_{2/2})_{b}(R¹SiO_{3/2})_{c}(SiO_{4/2})_{d}

(R¹₃SiO_{1/2})ₐ(R¹₂SiO_{2/2})_{b}(R¹SiO_{3/2})_{c}(SiO_{4/2})_{d}

In component (A1), about 2 to about 30 mol % of siloxane units, optionally about 10 mol % to about 30 mol %, or optionally about 15 mol % to about 30 mol %, of all the siloxane units in a molecule have epoxy-substituted organic groups. If there is greater than or equal to the lower limit of the range mentioned above of such siloxane units, the density of cross-linking during curing can increase. On the other hand, the amount is less than or equal to the upper limit of the range mentioned above can be suitable because it can bring about an increase in the heat resistance of the cured product. In the epoxy-functional monovalent hydrocarbon groups, the epoxy groups can be bonded to silicon atoms through alkylene groups, such that these epoxy groups are not directly bonded to the silicon atoms. The epoxy-functional silicone resin (A1) can be produced by well-known conventional manufacturing methods.

While there are no particular limitations concerning the weight-average molecular weight of the epoxy-functional silicone resin (A1), if the toughness of the cured product and its solubility in organic solvents are taken into consideration, in some embodiments the molecular weight is not less than about 10³ and not more than about 106. In one embodiment, the epoxy-functional silicone resin (A1) includes a combination of two or more kinds of such epoxy-functional silicone resins with different content and type of the epoxy-containing organic groups and monovalent hydrocarbon groups or with different molecular weights.

Component (A2) is an arbitrary component to provide the cured product with flexibility and impact strength.

In the formula (2), each R² is the same or different organic group selected from a C₁₋₆ monovalent aliphatic hydrocarbon group and a C₆₋₁₀ monovalent aromatic hydrocarbon group.

Examples of the C₁₋₆ monovalent aliphatic hydrocarbon groups in component (A2) include C₁₋₆ alkyl groups such as methyl groups, ethyl groups, propyl groups, butyl groups, and hexyl groups; C₂₋₆ alkenyl groups such as vinyl groups, allyl groups, and hexenyl groups; and C₁₋₆ halogenated alkyl groups such as 3-chloropropyl groups and 3,3,3-trifluoropropyl groups. Among these, methyl groups are generally preferred.

Examples of the C₆₋₁₀ monovalent aromatic hydrocarbon groups in component (A2) include phenyl groups, tolyl groups, xylyl groups, and naphthyl groups. Among these, phenyl groups are generally preferred.

In the formula (2), each X¹ is the same or different group selected from a monovalent epoxy-substituted organic group and an epoxy-functional siloxy group represented by the following general formula (3):

X²—R³₂SiO(SiR³₂O)ₓSiR³₂—R⁴—.

Examples of the monovalent epoxy-substituted organic groups for X¹ include glycidoxyalkyl groups such as 3-glycidoxypropyl groups, 4-glycidoxybutyl groups and 5-glycidoxypentyl groups; 3,4-epoxycycloalkyl alkyl groups such as 2-(3,4-epoxycylohexyl)ethyl, 3-(3,4-epoxycylohexyl)propyl, 2-(3,4-epoxy-3-methylcylohexyl)-2-methylethyl, 2-(2,3-epoxycylopentyl)ethyl, and 3-(2,3-epoxycylopentyl)propyl; and epoxyalkyl groups such as 2,3-epoxypropyl groups, 3,4-epoxybutyl groups, and 4,5-epoxypentyl groups. Among these, 3,4-epoxycycloalkyl alkyl groups are generally preferred.

In the formula (3), each R³ is the same or different C₁₋₆ monovalent aliphatic hydrocarbon group. Examples of the C₁₋₆ monovalent aliphatic hydrocarbon groups for R³ include C₁₋₆ alkyl groups such as methyl groups, ethyl groups, propyl groups, butyl groups, and hexyl groups; C₂₋₆ alkenyl groups such as vinyl groups, allyl groups, and hexenyl groups; and C₁₋₆ halogenated alkyl groups such as 3-chloropropyl groups and 3,3,3-trifluoropropyl groups. Among these, methyl groups are generally preferred.

In the formula (3), R⁴ is a C₂₋₆ alkylene group. Examples of the C₂₋₆ alkylene groups for R⁴ include ethylene groups, methylethylene groups, propylene groups, butylene groups, and hexylene groups. Among these, ethylene groups are generally preferred.

In the formula (3), X² is a monovalent epoxy-substituted organic group. Examples of the monovalent epoxy-substituted organic groups for X² include glycidoxyalkyl groups such as 3-glycidoxypropyl groups, 4-glycidoxybutyl groups and 5-glycidoxypentyl groups; 3,4-epoxycycloalkyl alkyl groups such as 2-(3,4-epoxycylohexyl)ethyl, 3-(3,4-epoxycylohexyl)propyl, 2-(3,4-epoxy-3-methylcylohexyl)-2-methylethyl, 2-(2,3-epoxycylopentyl)ethyl, and 3-(2,3-epoxycylopentyl)propyl; and epoxyalkyl groups such as 2,3-epoxypropyl groups, 3,4-epoxybutyl groups, and 4,5-epoxypentyl groups. Among these, 3,4-epoxycycloalkyl alkyl groups are generally preferred.

In the formula (3), “x” is a number of from about 0 to about 5, optionally from about 0 to about 2, or optionally about 0.

In the formula (2), “m” is a number of from about 0 to about 100, optionally from about 0 to about 20, or optionally from about 0 to about 10. If “m” is less than or equal to the upper limit of the range described above, mechanical strength of the cured product can increase.

The state of component (A2) at 25° C. is not limited, but it is generally a liquid. The viscosity at 25° C. of component (A2) is not limited; however, the viscosity is generally in a range of from about 5 to about 100 mPa-s. Note that in the present specification, viscosity is the value measured using a type B viscometer according to ASTM D 1084 at 23±2° C.

The content of component (A2) in the mixture of components (A1) and (A2) is not limited, but it is generally at most 80 mass %, optionally at most 70 mass %, or optionally in an amount of from about 10 mass % to about 70 mass %, or optionally in an amount of from about 15 mass % to about 65 mass %, of the mixture of components (A1) and (A2). If the content of component (A2) is greater than or equal to the lower limit of the range described above, cure sensitivity to amine of the cured product can increase. On the other hand, the content is less than or equal to the upper limit of the range described above, oxygen inhibition or retardance of the cured product can be occurred, inducing poor modulus and tensile strength.

Component (B) is at least one radically polymerizable compound having at least one acrylic or methacrylic group per molecule. Examples of component (B) include mono(meth)acrylate such as isobornyl acrylate, 2-hydroxyethyl methacrylate, and 2-phenoxyethyl acrylate; (meth)acrylate compounds of divalent alcohols, such as ethylene glycol di(meth)acrylate, diethylene glycol di(meth)acrylate, triethylene glycol di(meth)acrylate, propylene glycol di(meth)acrylate, dipropylene glycol di(meth)acrylate, tripropylene glycol di(meth)acrylate, 1,3-butanediol di(meth)acrylate, 1,4-butanediol di(meth)acrylate, 1,5-pentanediol di(meth)acrylate, isoprene glycol di(meth)acrylate, 1,6-hexanediol di(meth)acrylate, neopentyl glycol di(meth)acrylate, octanediol di(meth)acrylate, 1,2-cyclohexanediol di(meth)acrylate, 1,4-cyclohexanediol di(meth)acrylate, hydrogenated bisphenol-A di(meth)acrylate, ethoxylated bisphenol-A di(meth)acrylate, propoxylated bisphenol-A di(meth)acrylate, and 3-hydroxy-2,2-dimethylpropyl-3-hydroxy-2,2-dimethylpropyionate diacrylate; (meth)acrylate compounds of trivalent alcohols, such as glycerol di(meth)acrylate, glycerol tri(meth)acrylate, trimethylol ethane di(meth)acrylate, trimethylol ethane tri(meth)acrylate, trimethylol propane di(meth)acrylate, trimethylol propane tri(meth)acrylate, and tris[(meth)acryloxyethyl]isocyanurate; and (meth)acrylate compounds of tetravalent alcohols, such as erythritol tri(meth)acrylate, erythritol tetra(meth)acrylate, pentaerythritol tri(meth)acrylate, pentaerythritol tetra(meth)acrylate, diglycerol tri(meth)acrylate, diglycerol tetra(meth)acrylate, ditrimethylol propane tri(meth)acrylate, and ditrimethylol propane tetra(meth)acrylate; (meth)acrylate compounds of pentavalent alcohols, such as triglycerol tetra(meth)acrylate and triglycerol penta(meth)acrylate; (meth)acrylate compounds of hexavalent alcohols, such as dipentaerythritol penta(meth)acrylate and dipentaerythritol hexa(meth)acrylate; and (meth)acrylate silane or siloxane, such as 3-acryloxpropyl trimethoxysilane, 3-methacryloxypropyl trimethoxysilane, and siloxane having (meth)acrylate group at one molecular terminal.

Component (B) is commercially available, e.g., dipentaerythritol triacrylate (KAYARAD D-330 manufactured by Nippon Kayaku Co., Ltd.); dipentaerythritol tetraacrylate (KAYARAD D-320 manufactured by Nippon Kayaku Co., Ltd.); dipentaerythritol penta(meth)acrylate (KAYARAD D-310 manufactured by Nippon Kayaku Co., Ltd.); dipentaerythritol hexa(meth)acrylate (KAYARAD DPHA manufactured by Nippon Kayaku Co., Ltd., NK ESTER A-DPH-12E, manufactured by Shin-Nakamura Chemical Co., Ltd.); and a compound having a structure in which the (meth)acryloyl group is bonded through an ethylene glycol and/or a propylene glycol residue (for example, SR454 and SR499 which are commercially available products from Sartomer).

The content of component (B) is in an amount of from about 15 mass % to about 75 mass %, optionally in an amount of from about 15 mass % to about 65 mass %, or optionally in an amount of from about 15 mass % to about 60 mass %, of the total mass of components (A) to (D). If the content is greater than or equal to the lower limit of the range described above, oxygen inhibition of the present composition can increase and mechanical strength can decrease. On the other hand, it is less than or equal to the upper limit of the range described above, curing inhibition by amine compounds of the cured product can increase.

Component (C) is a photo acid generator and/or a thermal acid generator to enhance curing component (A). Any acid generator that is known by one of skill in the art can be used, such as sulfonium salts, iodonium salts, selenonium salts, phosphonium salts, diazonium salts, para-toluene sulfonates, trichloromethyl-substituted triazines, and trichloromethyl-substituted benzenes. Among these, the sulfonium salts and iodonium salts are preferable because the present composition exhibits an excellent curability by UV radiation or heat/UV radiation. For example, the sulfonium salt is a UV activated acid generator with absorbing relatively long wavelength light (up to 365 nm) and the iodonium salt is heat/UV activated acid generator with absorbing short wavelength light (<350 nm).

Examples of sulfonium salts can include salts represented by the formula: R^{c}₃S⁺X⁻. In the formula, R^{c} can stand for methyl, ethyl, propyl, butyl, and other C₁₋₆ alkyl groups; phenyl, naphthyl, biphenyl, tolyl, propylphenyl, decylphenyl, dodecylphenyl, and other C₁₋₂₄ aryl group or substituted aryl groups, and X⁻ in the formula can represent SbF₆⁻, AsF₆⁻, PF₆⁻, BF₄⁻, B(C₆F₅)₄⁻, HSO₄⁻, ClO₄⁻, CF₃SO₃ and other non-nucleophilic non-basic anions.

Examples of iodonium salts can include salts represented by the formula: R^{c}₂I⁺X⁻; examples of selenonium salts can include salts represented by the formula: R^{c}₃Se⁺X⁻; examples of phosphonium salts can include salts represented by the formula: R^{c}₄P⁺X⁻; examples of diazonium salts can include salts represented by the formula: R^{c}N₂⁺X⁻; with the R^{c} and X⁻in the formulas being the same as described herein for R^{c}₃S⁺X⁻.

Examples of para-toluene sulfonates can include compounds represented by the formula: CH₃C₆H₄SO₃R^{c}1, with the R^{c}1 in the formula standing for organic groups including electron-attracting groups, such as benzoylphenylmethyl groups, phthalimide groups, and the like.

Examples of trichloromethyl-substituted triazines can include compounds represented by [CC1₃]₂C₃N₃R^{c2}, with the R^{c2} in the formula standing for phenyl, substituted or unsubstituted phenylethyl, substituted or unsubstituted furanylethynyl, and other electron-attracting groups.

Examples of trichloromethyl-substituted benzenes can include compounds represented by CCl₃C₆H₃R^{c}R^{c3}, with the R^{c} in the formula being the same as described herein for R^{c}₃S⁺X⁻−and the R^{c3} standing for halogen groups, halogen-substituted alkyl groups, and other halogen-containing groups.

Examples of the acid generator can include triphenylsulfonium tetrafluoroborate, di(p-tertiary butylphenyl)iodonium hexafluoroantimonate, bis(dodecylphenyl)iodonium hexafluoroantimonate, 4-isopropyl-4′-methyldiphenyliodonium tetrakis(pentafluorophenyl)borate salt, and p-chlorophenyldiazonium tetrafluoroborate.

The content of component (C) is in an amount of from about 0.1 mass % to about 5 mass %, optionally in an amount of from about 0.5 mass % to about 5 mass %, optionally in an amount of from about 0.1 mass % to about 3 mass %, or optionally in an amount of from about 0.1 mass % to about 2 mass %, of the total mass of components (A) to (D). If the content of component (C) is greater than or equal to the lower limit of the range described above, the curable silicone composition get into yellowing and have poor pot-life due to too fast cure speed. On the other hand, the content is less than or equal to the upper limit of the range described above, curing speed of the cured product can slow down and eventually cannot be fully cured.

Component (D) is a photo radical polymerization initiator and/or a thermal radical polymerization initiator to enhance polymerizing component (B). Any radical polymerization initiator that is known by one of skill in the art can be used.

Examples of photo radical polymerization initiators for component (D) include acetophenone-based initiators, such as diethoxyacetophenone, 2-hydroxy-2-methyl-1-phenylpropan-1-one, 4′-isopropyl-2-hydroxy-2-methylpropiophenone, 2-hydroxymethyl-2-methylpropiophenone, 2,2-dimethoxy-1,2-diphenylethan-1-one, p-dimethylaminoacetophenone, p-tertiary-butyldichloroacetophenone, p-tertiary-butyltrichloroacetophenone, p-azidobenzalacetophenone, 1-hydroxycyclohexyl phenyl ketone, 2-methyl-1-[4-(methylthio)phenyl]-2-morpholinopropanone-1, 2-benzyl-2-dimethylamino-1-(4-morpholinophenyl)-butanone-1, benzoin, benzoin methyl ether, benzoin ethyl ether, benzoin isopropyl ether, benzoin n-butyl ether, benzoin isobutyl ether, and oligomers of 2-hydroxy-2-methyl-1-[4-vinyl-(1-methylvinyl)phenyl]propanone; benzil-based initiators, such as diphenyl diketone and bis(4-methoxyphenyl) diketone; benzophenone-based initiators, such as benzophenone, methyl o-benzoylbenzoate, Michler's ketone, 4,4′-bisdiethylaminobenzophenone, 2-hydroxy-2-methyl propiophenone, 4,4′-dichlorobenzophenone, and 4-benzoyl-4′-methyldiphenyl sulfide; thioxanthone-based initiators, such as thioxanthone, 2-methylthioxanthone, 2-ethylthioxanthone, 2-chlorothioxanthone, 2-isopropylthioxanthone, and 2,4-diethylthioxanthone; acylphosphine oxide-based initiators, such as 2-methylbenzoyldiphenylphosphine oxide, 2,4,6-trimethylbenzoyldiphenylphosphine oxide, methyl 2,4,6-trimethylbenzoylphenylphosphinate, bis(2,6-dimethoxybenzoyl)phenylphosphine oxide, bis(2,4,6-trimethylbenzoyl)phenylphosphine oxide, and bis(2,6-dimethoxybenzoyl)-2,4,4-trimethylpentylphosphine oxide; and oxime-based initiators, such as 1-{(4-phenylthio)phenyl}-1,2-butanedione-2-(O-benzoyloxime), 1-{(4-phenylthio)phenyl}-1,2-octanedione-2-(O-benzoyloxime), 1-{(4-phenylthio)phenyl}-1-octanone-1-(O-acetyloxime), 1-{4-(2-hydroxyethoxyphenylthio)phenyl}-1,2-propanedione-2-(O-acetyloxime), 1-[9-ethyl-6-(2-methylbenzoyl)-9H-carbazol-3-yl]ethanone-1-(O-acetyloxime), and (9-ethyl-6-nitro-9H-carbazol-3-yl){4-(2-methoxy)-1-methylethoxy}-2-methylphenyl}methanone(O-acetyloxime). It is preferable that the aforementioned photo radical polymerization initiator is a benzophenone-based initiator because of the good reactivity of component (B); 2-hydroxy-2-methyl propiophenone is even more preferable. One type of photo radical polymerization initiator may be used, or two or more types thereof may be used in combination.

Examples of thermal radical polymerization initiators for component (D) include azo compounds, such as azobenzene, azobenzene-p-sulfonic acid, azobisdimethylvaleronitrile, azobisisobutyronitrile, and a combination thereof; and organic peroxide compounds, such as benzoyl peroxide, dibenzoyl peroxide, 4-monochlorobenzoyl peroxide, dicumyl peroxide, tert-butyl cumyl peroxide, tert-butyl peroxy benzoate, 2,4-dichlorobenzoyl peroxide, di-tert-butyl peroxide, di-tert-hexyl peroxide, tert-butyl cumyl peroxide, 1,1-bis(t-butyl peroxy)-3,3,5-trimethylcyclohexane, 2,5-dimethyl-2,5-bis (tert-butyl peroxy) hexyne-3, di-(tert-butyl peroxy isopropyl) benzene, 1,6-bis (tert-butyl peroxy carboxy) hexane, di-(4-methyl benzoyl) peroxide, di-(2-methylbenzoyl) peroxide, tert-butyl peroxyisopropyl monocarbonate, di-(2-tert-butyl peroxy isopropy) benzene, or combinations of two or more thereof. The thermal radical polymerization initiator used as component (D) in the present invention is preferably the organic peroxide with a half-life of 10 hours at a temperature of 80° C. or higher, optionally 90° C. or higher, or optionally 100° C. or higher. This is because when the temperature is greater than or equal to the lower limit described above, the present composition exhibits a good stability at a room temperature. Note that the upper limit of the temperature is not particularly limited, however, when the temperature is too high, the present composition tends to not cure fully, so that, the temperature is preferably 130° C. or lower. Examples of such organic peroxide include dicumyl peroxide, tert-butyl cumyl peroxide, di-tert-butyl peroxide, 2,5-dimethyl-2,5-bis (tert-butyl peroxy) hexyne-3, and di-(2-tert-butyl peroxy isopropy) benzene. In general, dicumyl peroxide is most preferable because of good miscibility with other components in the present composition.

The content of component (D) is in an amount of from about 0.1 mass % to about 5 mass %, optionally in an amount of from about 0.1 mass % to about 3 mass %, optionally in an amount of from about 0.1 mass % to about 2 mass %, or optionally in an amount of from about 0.5 mass % to about 2 mass %, of the total mass of components (A) to (D). If the content of component (D) is greater than or equal to the lower limit of the range described above, the curable silicone composition is not stable at room temperature and have poor pot-life. On the other hand, the content is less than or equal to the upper limit of the range described above, radical component in the cured product cannot be fully cured and more oxygen inhibition can be observed.

The present composition comprises components (A) to (D) described above; however, to impart better adhesion properties and mechanical properties to a cured product of the present composition, an adhesion promoter, and/or a photosensitizer, and/or an alcohol, and/or an inorganic filler can be utilized.

Examples of adhesion promoters include epoxy-functional alkoxysilane such as 3-glycidoxypropyltrimethoxysilane, 3-glycidoxypropyltriethoxysilane, 2-(3,4-epoxycyclohexyl)ethyldimethoxysilane, 2-(3,4-epoxycyclohexyl)ethyldiethoxysilane and combinations thereof; unsaturated alkoxysilanes such as vinyltrimethoxysilane, allyltrimethoxysilane, allyltriethoxysilane, hexenyltrimethoxysilane, undecylenyltrimethoxysilane, 3-methacryloyloxypropyl trimethoxysilane, 3-methacryloyloxypropyl triethoxysilane, 3-acryloyloxypropyl trimethoxysilane, 3-acryloyloxypropyl triethoxysilane, and combinations thereof; an epoxy-functional siloxane with silicon atom-bonded alkoxy groups such as a reaction product of a hydroxy-terminated polyorganosiloxane with an epoxy-functional alkoxysilane (e.g. such as one of those described above), or a physical blend of the hydroxy-terminated polyorganosiloxane with the epoxy-functional alkoxysilane. The adhesion promoter may comprise a combination of an epoxy-functional alkoxysilane and an epoxy-functional siloxane. For example, the adhesion promoter is exemplified by a mixture of 3-glycidoxypropyltrimethoxysilane and a reaction product of hydroxy-terminated methylvinylsiloxane with 3-glycidoxypropyltrimethoxysilane, or a mixture of 3-glycidoxypropyltrimethoxysilane and a hydroxy-terminated methylvinylsiloxane, or a mixture of 3-glycidoxypropyltrimethoxysilane and a hydroxy-terminated methylvinyl/dimethylsiloxane copolymer.

The content of adhesion promotor is not limited, but if utilized, it is generally in an amount of from about 0.01 to about 5 mass %, or optionally in an amount of from about 0.1 to about 2 mass %, of the total mass of components (A) to (D). If the content is greater than or equal to the lower limit of the range described above, adhesion properties of the cured product can increase. On the other hand, it is less than or equal to the upper limit of the range described above, mechanical properties of the cured product can increase.

Examples of the photosensitizers include isopropyl-9H-thioxanthen-9-one, anthrone, 1-hydroxycyclohexyl-phenylketone, 2,4-diethyl-9H-thioxanthen-9-one, 2-isopropyl thioxanthene, 2-hydroxy-2-methyl-phenylpropan-1-one, 2,6-bis(1,1-dimethylethyl)-4-methylphenol (BHT), pentaerythritol tetrakis[3-(3,5-di-tert-butyl-4-hydroxyphenyl)propionate], thiodiethylene bis[3-(3,5-di-tert-butyl-4-hydroxyphenyl)propionate], octadecyl-3-(3,5-di-tert-butyl-4-hydroxyphenyl)propionate, 2,4-dimethyl-6-(1-methylpentadecyl)phenol, diethyl[{3,5-bis(1,1-di-tert-butyl-4-hydroxyphenyl)methyl}phosphonate, 3 3′,3″,5,5′,5″-hexane-tert-butyl-4-a,a′,a″-(mesitylene-2,4,6-tolyl)tri-p-cresol, 4,6-bis(octylthiomethyl)-o-cresol, ethylenebis(oxyethylene)bis[3-(5-tert-butyl-4-hydroxy-m-tolyl)propionate], and hexamethylene bis[3-(3,5-di-tert-butyl-4-hydroxyphenyl)propionate].

The content of the photosensitizer is not limited, but if utilized, it is generally in a range of from about 0.001 to about 1 mass %, optionally in a range of from about 0.005 to about 0.5 mass %, or optionally in a range of from about 0.005 to about 0.1 mass %, of the total mass of components (A) to (D) and the photosensitizer. If the content of the photosensitizer is greater than or equal to the lower limit of the range described above, curability of the cured product can increase. On the other hand, it is less than or equal to the upper limit of the range described above, optical clearance of the cured product can increase.

Examples of the alcohol include monovalent alcohols such as ethyl alcohol, isopropyl alcohol, isobutyl alcohol, 1-decanol, 1-dodecanol, 1-octanol, oleyl alcohol, 1-hexadecanol, and stearyl alcohol; and multivalent alcohols such as ethylene glycol, diethylene glycol, propylene glycol, 1,10-decanediol, glycerol, and pentaerythritol.

The content of the alcohol is not limited, but if utilized, it is generally in an amount of from about 0.01 to about 10 mass %, or optionally in an amount of from about 0.1 to about 10 mass %, of the total mass of components (A) to (D) and the alcohol.

An inorganic filler enhances mechanical strength of a cure product. Examples of the filler include one or more of finely divided treated or untreated precipitated or fumed silica; precipitated or ground calcium carbonate, zinc carbonate; clays such as finely divided kaolin; quartz powder; aluminum hydroxide; zirconium silicate; diatomaceous earth; wollastonite; pyrophylate; and metal oxides such as fumed or precipitated titanium dioxide, cerium oxide, magnesium oxide powder, zinc oxide, and iron oxide.

The content of the filler is not limited, but if utilized, it is generally in a range of from about 1 to about 95 mass %, optionally in a range of from about 5 to about 95 mass %, or optionally in a range of from about 5 to about 90 mass %, of the total mass of components (A) to (D) and the filler.

The present composition can be cured by irradiation of UV ray (or ultraviolet (“UV”) light) and/or heating. For example, low pressure, high pressure or ultrahigh pressure mercury lamp, metal halide lamp, (pulse) xenon lamp, or an electrodeless lamp is useful as an UV lamp.

The present composition forms a cured product when cured by irradiation with UV ray. This cured product according to the present invention has a hardness, as measured using Shore A hardness specified in ASTM D2240, in the range of from at least 20 to not more than 95, typically in the range of from at least 30 to not more than 80, and more typically in the range of from at least 30 to not more than 70. Otherwise, this cured product according to the present invention has a hardness, as measured using Shore D hardness specified in ASTM D2240, of at most 60, and typically at most 50. The reasons for this are as follows: the cured product may have insufficient strength when its hardness is less than the lower limit for the cited range; when, on the other hand, the upper limit for the cited range is exceeded, the flexibility of the cured product under consideration tends to be inadequate.

The cured product, because it is flexible and highly transparent, is useful as an optical member or component that is permeable to light, e.g., visible light, infrared, ultraviolet, far ultraviolet, x-ray, laser, and so forth. The cured product is also useful as an optical member or component that must be flexible, e.g., due to use in a flexed or bent condition, and is also useful as an optical member or component for devices involved with high energy, high output light. In addition, an article or component having a flexible cured product layer can be made by making a composite in which the cured product is formed into a single article or body with any of various substrates, and an impact- and stress-relaxing function can also be expected from the cured product layer.

### Examples

The dual curable silicone composition of the present invention will now be described in detail using Practical and Comparative Examples. Note that, in the formulas, “Me”, “Pr”, “Ph” and “Ep” respectively indicates methyl group, propyl group, phenyl group and 2-(3,4-epoxycyclohexyl)ethyl group. The structure of the epoxy-functional silicone resins used in the examples was determined by conducting ¹³C NMR and ²⁹Si NMR measurements. The weight-average molecular weight of the epoxy-functional silicone resins was calculated using GPC based on comparison with polystyrene standards. Viscosity of epoxy-functional silicones and silicone resin was measured as follows.

### <Viscosity>

Viscosity at 23±2° C. was measured by using a type B viscometer (Brookfield HA or HB Type Rotational Viscometer with using Spindle #52 at 5 rpm) according to ASTM D 1084 “Standard Test Methods for Viscosity of Adhesive”.

### Practical Examples 1-10 and Comparative Examples 1-7

The following components were used to prepare dual curable silicone compositions (mass %) shown in Table 1.

The following epoxy-functional silicone resin was used as component (A1).
(a1): an epoxy-functional silicone resin with a weight-average molecular weight of 2,000 to 6,000 and represented by the following average unit formula:

(MePhSiO_{2/2})_{0.34}(PrSiO_{3/2})_{0.50}(EpSiO_{3/2})_{0.16}

The following epoxy-functional silicone was used as component (A2).
(a2): an epoxy-functional silicone with a viscosity of 40 mPa-s, a weight-average molecular weight of 382, and represented by the following formula:

Ep-SiMe₂OSiMe₂-Ep

The following acryl monomers were used as component (B).
(b1): isobornyl acrylate
(b2): 2-hydroxyethyl methacrylate
(b3): 3-hydroxy-2,2-dimethylpropyl 3-hydroxy-2,2-dimethylpropionate diacrylate
(b4): 2-phenoxyethyl acrylate

The following photo/heat acid generators were used as component (C).
(c1): 4-isopropyl-4′-methyldiphenyliodonium tetrakis(pentafluorophenyl) borate salt (TR-PAG-30408 from TRONYL)
(c2): a triarylsulfonium borate salt (CPI-310B from TRONYL)

The following photo/heat radical initiators were used as component (D).
(d1): 2-hydroxy-2-methyl propiophenone
(d2): dicumyl peroxide

### <Curability of Dual Curable Silicone Composition>

About 0.1 to 3 g of each dual curable silicone composition was loaded into a slide glass coated in advance with triethylamine or triisopropanolamine. After leveling the surface level by bar coater, it goes through Metal halide UV Lamps with D bulb in the light intensity of 5000 mW/cm² or heating (150° C. for 1 hr.), under air to cure the dual curable silicone compositions. Curability of the dual curable silicone composition was evaluated. The results are shown in Table 1.

### <Hardness of Cured Product>

Hardness of cured product was measured by using Shore D hardness or Shore A hardness specified in ASTM D2240.

### <Surface Tack of Cured Product>

Surface tack of cured product was evaluated by touching with a finger.

TABLE 1

| | | | Practical Examples | | | | | |
|---|---|---|---|---|---|---|---|---|
| | | | 1 | 2 | 3 | 4 | 5 | 6 |
| Dual | (A) | (a1) | 40.00 | 40.00 | 40.00 | 40.00 | 20.00 | 20.00 |
| Curable | | (a2) | 10.00 | 0 | 37.80 | 37.80 | 36.84 | 36.84 |
| silicone | (B) | (b1) | 47.80 | 57.80 | 20.00 | 20.00 | 40.96 | 0 |
| composition | | (b2) | 0 | 0 | 0 | 0 | 0 | 40.96 |
| (mass %) | | (b3) | 0 | 0 | 0 | 0 | 0 | 0 |
| | | (b4) | 0 | 0 | 0 | 0 | 0 | 0 |
| | (C) | (c1) | 1.20 | 1.20 | 1.20 | 1.20 | 1.20 | 1.20 |
| | | (c2) | 0 | 0 | 0 | 0 | 0 | 0 |
| | (D) | (d1) | 0 | 0 | 0 | 0 | 0 | 0 |
| | | (d2) | 1.00 | 1.00 | 1.00 | 1.00 | 1.00 | 1.00 |
| Under air | Curability | | Cured | Cured | Cured | Cured | Cured | Cured |
| | Hardness | | | | | | | |
| | Shore A | | 50 | 40 | — | — | 60 | 50 |
| | Shore D | | — | — | 45 | 45 | — | — |
| | Surface tack | | No tack | No tack | No tack | No tack | No tack | No tack |
| Under | Curability | | Cured | Cured | Cured | Cured | Cured | Cured |
| amine | Hardness | | | | | | | |
| compound | Shore A | | 45 | 40 | — | — | 45 | 50 |
| | Shore D | | — | — | 40 | 40 | — | — |
| | Surface tack | | No tack | No tack | No tack | No tack | No tack | No tack |
| | | | | | | | Comparative | |
| | | | Practical Examples | | | | Examples | |
| | | | 7 | 8 | 9 | 10 | 1 | 2 |
| Dual | (A) | (a1) | 20.00 | 20.00 | 40.00 | 40.00 | 20.00 | 20.00 |
| Curable | | (a2) | 36.84 | 36.84 | 10.00 | 10.00 | 78.80 | 67.80 |
| silicone | (B) | (b1) | 0 | 0 | 47.80 | 47.80 | 0 | 10.00 |
| composition | | (b2) | 0 | 0 | 0 | 0 | 0 | 0 |
| (mass %) | | (b3) | 40.96 | 0 | 0 | 0 | 0 | 0 |
| | | (b4) | 0 | 40.96 | 0 | 0 | 0 | 0 |
| | (C) | (c1) | 1.20 | 1.20 | 1.20 | 0 | 1.20 | 1.20 |
| | | (c2) | 0 | 0 | 0 | 1.20 | 0 | 0 |
| | (D) | (d1) | 0 | 0 | 1.00 | 1.00 | 0 | 0 |
| | | (d2) | 1.00 | 1.00 | 0 | 0 | 0 | 1.00 |

| | | | | | | | |
|---|---|---|---|---|---|---|---|
| Under air | Curability | Cured | Cured | Cured | Cured | Cured | Cured |
| | Hardness | | | | | | |
| | Shore A | 60 | 60 | 50 | 60 | — | — |
| | Shore D | — | — | — | — | 75 | 60 |
| | Surface tack | No tack | No tack | No tack | No tack | No tack | No tack |
| Under | Curability | Cured | Cured | Cured | Cured | Uncured | Uncured |
| amine | Hardness | | | | | | |
| compound | Shore A | 60 | 60 | 50 | 60 | — | — |
| | Shore D | — | — | — | — | — | — |
| | Surface tack | No tack | No tack | No tack | No tack | Tack | Tack |

| | | | Comparative Examples | | | | |
|---|---|---|---|---|---|---|---|
| | | | 3 | 4 | 5 | 6 | 7 |
| Dual | (A) | (a1) | 10.00 | 40.00 | 40.00 | 20.00 | 10.00 |
| Curable | | (a2) | 7.80 | 11.00 | 11.20 | 67.80 | 7.80 |
| silicone | (B) | (b1) | 80.00 | 47.80 | 47.80 | 10.00 | 80.00 |
| composition | | (b2) | 0 | 0 | 0 | 0 | 0 |
| (mass %) | | (b3) | 0 | 0 | 0 | 0 | 0 |
| | | (b4) | 0 | 0 | 0 | 0 | 0 |
| | (C) | (c1) | 1.20 | 1.20 | 0 | 1.20 | 1.20 |
| | | (c2) | 0 | 0 | 0 | 0 | 0 |
| | (D) | (d1) | 0 | 0 | 0 | 1.00 | 1.00 |
| | | (d2) | 1.00 | 0 | 1.00 | 0 | 0 |

| | | | | | | |
|---|---|---|---|---|---|---|
| Under air | Curability | Uncured | Cured | Uncured | Cured | Uncured |
| | Hardness | | | | | |
| | Shore A | — | 40 | — | — | — |
| | Shore D | — | — | — | 60 | — |
| | Surface tack | Tack | No tack | Tack | No tack | Tack |
| Under | Curability | Cured | Uncured | Cured | Uncured | Cured |
| amine | Hardness | | | | | |
| compound | Shore A | 30 | — | — | — | 30 |
| | Shore D | — | — | — | — | — |
| | Surface tack | No tack | Tack | Tack | Tack | No tack |

### INDUSTRIAL APPLICABILITY

The dual curable silicone composition of the present invention can be cured without being inhibited by air and amine compounds. Therefore, the present composition is useful as various adhesives, encapsulants, coating agents, and the like for electric/electronic applications.

1. A dual curable silicone composition comprising:
(A) an epoxy-functional silicone selected from (A1) an epoxy-functional silicone resin represented by the following average unit formula (1):
(R¹₃SiO_{1/2})ₐ(R¹₂SiO_{2/2})_{b}(R¹SiO_{3/2})_{c}(SiO_{4/2})_{d}
wherein each R¹ is the same or different organic group selected from a C₁₋₆ monovalent aliphatic hydrocarbon group, a C₆₋₁₀ monovalent aromatic hydrocarbon group, and a monovalent epoxy-substituted organic group, provided that at least about 15 mol % of the total R¹ are the C₆₋₁₀ monovalent aromatic hydrocarbon groups; and “a”, “b”, “c” and “d” are numbers that satisfy the following conditions: 0≤a<0.4, 0<b<0.5, 0<c<1, 0≤d<0.4, 0.1≤b/c≤0.6, and a+b+c+d=1; and about 2 to about 30 mol % of the total siloxane units have the monovalent epoxy-substituted organic groups,
or a mixture of component (A1) mentioned above and (A2) an epoxy-functional silicone represented by the following general formula (2):
X¹—R²₂SiO(SiR²₂O)ₘSiR²₂—X¹
wherein each R² is the same or different organic group selected from a C₁₋₆ monovalent aliphatic hydrocarbon group and a C₆₋₁₀ monovalent aromatic hydrocarbon group; each X¹ is the same or different group selected from a monovalent epoxy-substituted organic group and an epoxy-functional siloxy group represented by the following general formula (3):
X²—R³₂SiO(SiR³₂O)ₓSiR³₂-R⁴—
wherein each R³ is the same or different C₁₋₆ monovalent aliphatic hydrocarbon group; R⁴ is a C₂₋₆ alkylene group; X² is a monovalent epoxy-substituted organic group; “x” is a number of from about 0 to about 5; and “m” is a number of from about 0 to about 100;
(B) at least one radically polymerizable compound having at least one acrylic or methacrylic group per molecule, in an amount of from about 15 mass % to about 75 mass % of the total mass of components (A) to (D);
(C) a photo acid generator and/or a thermal acid generator, in an amount of from about 0.1 mass % to about 5 mass % of the total mass of components (A) to (D); and
(D) a photo radical polymerization initiator and/or a thermal radical polymerization initiator, in an amount of from about 0.1 mass % to about 5 mass % of the total mass of components (A) to (D).

2. The dual curable silicone composition according to claim 1, wherein a content of component (A2) is at most 80 mass % of the mixture of components (A1) and (A2).

3. The dual curable silicone composition according to claim 1, wherein the monovalent epoxy-substituted organic groups in component (A) are glycidoxyalkyl groups, 3,4-epoxycyclohexylalkyl groups, or epoxyalkyl groups.

4. The dual curable silicone composition according to claim 1, wherein component (B) is isobornyl acrylate, 2-hydroxyethyl methacrylate, 3-hydroxy-2,2-dimethylpropyl 3-hydroxy-2,2-dimethylpropyionate diacrylate, or 2-phenoxyethyl acrylate.

5. The dual curable silicone composition according to claim 1, wherein component (C) is a sulfonium salt or an iodonium salt.

6. The dual curable silicone composition according to claim 1, wherein the photo radical polymerization initiator for component (D) is an acetophenone-based initiator, a benzil-based initiator, a benzophenone-based initiator, a thioxanthone-based initiator, an acylphosphine oxide-based initiator, or an oxime-based initiator.

7. The dual curable silicone composition according to claim 1, wherein the thermal radical polymerization initiator for component (D) is an organic peroxide with a half-life of 10 hours at a temperature of 80° C. or higher.
